(19) United States
(12) Patent Application Publication
(10) Pub. No.: US 2005/0048889 A1
(43) Pub. Date: Mar. 3, 2005

(54) Container for scaling fish

(76) Inventor: David L. Barron, Chicago, IL (US)

Correspondence Address: Richard C. Litman;LITMAN LAW OFFICES, LTD., P.O. Box 15035, Arlington, VA, 22215, US

(21) Appl. No.: 10/455,384

(22) Filed: Jun. 6, 2003

(51) Int. Cl. A22C 25/02

(52) U.S. Cl. 452/105

(57) ABSTRACT

A container for scaling fish prevents the scattering of loosened scales from the fish during scaling. The present container has an open top with liquid impervious walls and floor. The floor slopes to a drain, which may pass through the floor or through a low point along one wall. The drain includes a guard or screen therein, to prevent passage of fish scales or similarly sized articles therethrough. The container is filled with water with the drain capped, or the container is placed in a sink or basin which is filled with water. A fish may then be placed in the container and scaled, with the viscosity and density of the water precluding scattering of the removed scales. When scaling has been completed, the water is drained from the container, with the scales carried to the drain by the water flow and captured by the guard for ease of removal.

### BACKGROUND OF THE INVENTION

1. Field of the Invention

The present invention relates generally to sport and/or commercial fishing and the cleaning of fish, and more specifically to a device and method for removing the scales from the fish in a neat and tidy manner. The present invention comprises a container which is filled with water, with the fish being scaled while being held within the container. The removed scales are prevented from scattering by the viscosity and density of the water, and collect at a low point in the container when the water is drained therefrom. The scales are then easily removed from this single collection point, for discarding.

2. Description of the Related Art

Fishing is an extremely popular sport for many people, and the value of commercial fishing is also obvious. However, as with any animal which is used for food, the animal must be cleaned and processed after catching or killing. In the case of fishing, this not only involves the removal of internal organs and inedible structure, but in most cases it also involves the removal of the inedible scales from the exterior of the fish.

The removal of scales from fish is not a particularly difficult task, but it can be tedious and is generally somewhat messy, perhaps even more so than other aspects of cleaning the fish. Fish scales are generally relatively small, thin, and light weight, and their removal generally involves a scraping action from the tail toward the head of the fish, using a relatively sharp edged object to get beneath the edges of the scales and work them loose from the underlying skin surface. When this task is being carried out, the scales generally flip from the skin surface of the fish, and scatter to at least some degree. In many areas, anglers are required to clean up after cleaning fish, and the cleanup of scales which have been scattered about can be a difficult chore. This problem is all the more critical when the fish has been taken home before cleaning, and is being scaled and cleaned in the home environment.

Accordingly, a need will be seen for a container for retaining loosened and removed fish scales during the scaling of a fish. The present container accomplishes this goal, and further acts to collect the removed scales in a single point when the container is emptied, thus facilitating the removal of the scales from the container. The present container may be formed to any practicable size, for use by sport or commercial anglers as desired.

A discussion of the related art of which the present inventor is aware, and its differences and distinctions from the present invention, is provided below.

U.S. Pat. No. 2,110,341 issued on Mar. 8, 1938 to Carl J. Rindt, titled “Fish Scaling Apparatus,” describes a generally rectangular container having a lid and an expanded metal grid or floor therein for placement of a fish thereon, and a series of slots for the insertion and manipulation of gripping and scaling tools therethrough. Rindt clearly recognizes the problems in fish scales tending to fly about and scatter during the scaling operation, as he notes on page 1, col. 2, lines 24-26. However, his container cannot hold water, due to the slots in the sides and ends thereof for the insertion and manipulation of tools. While fish scales would tend to be retained within the closed box of the Rindt device, the device itself would be difficult to clean afterwards, as the scales would tend to fly about and adhere to all of the interior surfaces of the device. The process of washing the device out with water, would likely prove as tedious and time consuming as scaling the fish in the first place.

U.S. Pat. No. 3,590,423 issued on Jul. 6, 1971 to Thomas V. Messer, titled “Cleaning Apparatus For Fish,” describes a relatively deep container having an open top with an open tray attachable across the open top. Messer is more concerned with the cleaning of fish and the handling or removal of internal organs and other inedible components, than he is with the scaling of the fish. Messer does not particularly address the problem of scaling fish, but the open apparatus and upper tray would do little, if anything, to retain fish scales during the scaling operation.

U.S. Pat. No. 3,785,008 issued on Jan. 15, 1974 to Amelia M. Parker, titled “Fish Scaler,” describes an open board structure having a folding extension apparatus between a base board and a scaling board. While Parker provides for a container at one end of the apparatus, she does not enclose the structure or otherwise act to prevent loosened scales from flying about. This is an ongoing problem in the scaling of fish, which problem is finally solved by the present fish scaling container.

U.S. Pat. No. 3,877,144 issued on Apr. 15, 1975 to Michael P. LeBlanc, titled “Fishing Accessory,” describes a combination cutting and scaling board, with a scaling knife removably attached thereto. The flat surface of the board, normally used as the bottom support surface, is adaptable for use in supporting a fish during the scaling operation. As in the case of the Parker board discussed immediately above, the LeBlanc scaling board is completely open and does nothing to prevent scales from scattering during the scaling operation.

U.S. Pat. No. 4,229,858 issued on Oct. 28, 1980 to Stephen M. Baxter et al., titled “Boat-Mountable Fish-Cleaning Tray,” describes an open tray which is attachable to the gunwale or other structure of a boat. The tray has an adjustably positionable cleaning and/or scaling board therein. Baxter et al. provide a small channel at one end of the device to guide refuse outwardly from the tray, but they do not address the problem of scales scattering during the scaling operation, which problem is addressed and solved by the present invention.

U.S. Pat. No. 4,839,942 issued on Jun. 20, 1989 to James B. Damp, titled “Fish Scaling Apparatus,” describes a motorized device having a water tank with a horizontal drum partially submerged in the water tank. The drum includes a series of inwardly disposed projections, which contact and remove the scales of a fish placed within the drum. Fish are placed within the drum and power is applied to rotate the drum, with the random motion of the fish within the rotating drum eventually causing most of the surface scales to be contacted by the drum projections to remove the scales from the fish. The Damp device cannot provide organized scale removal, as can the manual scale removal used with the present invention. Moreover, the Damp device requires a source of electrical power and is difficult to clean, as the rotating drum must be removed from the apparatus and cleaned internally, which is difficult considering the inwardly disposed projections of the drum. The water in the outer tank would appear to do little to wash the scales from the device, as the scales would be confined within the rotating drum, according to FIG. 1A of the Damp U.S. Patent.

U.S. Pat. No. 4,846,076 issued on Jul. 11, 1989 to William H. Menges Sr. et al., titled “Bucket Board And Seat Apparatus,” describes a molded plastic structure configured for securing about a portion of the rim of a bucket. While their board may be used for cleaning and/or scaling fish, Menges Sr. et al. do not provide any specific structure for fish scaling, and use of their board for such purpose results in the same problem noted above of being unable to confine the loose scales.

U.S. Pat. No. 4,876,768 issued on Oct. 31, 1989 to Clarence K. Bright, titled “Fish Scaling Apparatus,” describes a mechanical device comprising a bucket with a barbed agitator installed therein on a vertical axis. The agitator is rotated by a hand operated recoil mechanism extending through the lid of the bucket. Fish are placed within the bucket and the bucket is filled with water, the agitator and lid installed, and the recoil mechanism actuated to rotate the agitator to randomly remove scales from the fish contained within the bucket. The problem with such mechanized devices is that their scale removal is dependent upon random contact with the surface of the fish within the device, just as in the case of the device of the Damp '942 U.S. Patent discussed further above. In addition, Bright does not provide any means of collecting the removed scales at one point in the container for ease of removal from the container, as provided by the present invention. The bucket of the Bright apparatus must still be rinsed and cleaned conventionally, and the agitator with its projections would prove even more difficult to clean.

U.S. Pat. No. 4,935,991 issued on Jun. 26, 1990 to Wayne Tourney, titled “Fish Cleaning Station And Method Of Using The Same,” describes a device including provision for rinse water and a drain with a motorized disposal unit therein. The Tourney device is more adapted for use in commercial fish cleaning operations, than it is to the sport fishing hobby. Tourney does not disclose any specific means for using his device for scaling fish, nor for containing any scales removed from the fish.

U.S. Pat. No. 4,977,644 issued on Dec. 18, 1990 to Andrew L. Evans et al., titled “Fish Holder,” describes a board having adjustable side members for securing a fish therebetween. While Evans et al. provide means for holding the tail of a fish for scaling, they do not provide any other specific structure to facilitate scaling a fish using their device, nor do they provide any means of preventing the scales from scattering during the scaling operation.

U.S. Pat. No. 5,129,855 issued on Jul. 14, 1992 to Richard C. Bruckert et al., titled “Fish Scaler Apparatus,” describes a cylindrical outer bucket having a plurality of drain openings in the floor thereof and a central water inlet fitting. An interiorly barbed inner liner installs within the outer bucket, with a rotary paddle agitator installing within the inner liner. The Bruckert et al. scaler operates on much the same principle as other rotary scaler devices discussed further above, e.g. the device of the Bright '768 U.S. Patent. However, Bruckert et al. provide for a stream of water flowing into the bottom of the container to provide a flushing action during the scaling operation. A series of drains are provided in the bottom of the device, with the drains each having “partition walls” which are apparently intended to block the passage of fish scales from the drains. The Bruckert et al. device requires the use of a flowing water input source if water is to be used, as no means is provided to block the drains. Moreover, the multiple drains of the Bruckert et al. device are relatively more difficult to clean than the single drain of the present fish scaling container.

U.S. Pat. No. 5,232,395 issued on Aug. 3, 1993 to Harold W. Rushing, titled “Fish Scaling Device,” describes two embodiments of a hand held block having a flange(s) extending therefrom for scraping the scales from a fish. No container for retaining the removed scales, is disclosed by Rushing.

U.S. Pat. No. 5,542,359 issued on Aug. 6, 1996 to Donald J. Polries, titled “Collapsible Fish Cleaning Table,” describes a table having a clamp thereon for securing a fish thereto, and an opening for the collection of waste from cleaning a fish thereon. Polries does not describe any specific structure for scaling a fish, and does not provide any means of containing scales removed during a scaling operation.

U.S. Pat. No. 5,628,681 issued on May 13, 1997 to Robert J. White et al., titled “Fish Cleaning Board,” describes a board configured for placement atop an ice chest or table. The White et al. board includes a drain at one edge thereof, for draining liquids from the cleaning operation. However, the White et al. board is completely open, and does nothing to prevent scales from scattering if the device is used for scaling fish.

U.S. Pat. No. 5,897,433 issued on April 27, 1999 to Victor Kendrick, titled “Fish Scaling Net,” describes a tent-like device with arm openings in one side thereof and a closable panel for placing a fish therein. No floor is provided, as the device is intended to be placed over a sink or the like. The Kendrick device is difficult to clean, as no water is contained therein to prevent scattering of the scales as the fish is scaled; scales would scatter widely across the entire interior of the device.

U.S. Pat. No. 6,527,635 issued on Mar. 4, 2003 to Archie J. Lundy, titled “Game And Fish Cleaning Enclosure,” describes a board having support members at each end thereof for supporting a conventional trash bag or the like thereover. The bag is used only for containing waste left over after cleaning a fish on the board, however. It is not adapted for enclosing the board during cleaning operations, as no access holes are provided in the bag. The Lundy apparatus thus does nothing to prevent the scatter of fish scales during a scaling operation.

Finally, International Patent Publication No. 90/07279 published on Jul. 12, 1990 to Mervin M. Onyshko, titled “Fish Scaler,” describes a relatively small closed container having a handle extending from one side thereof. The bottom of the container includes at least one scale scraping blade extending therefrom, with a passage at the edge of the blade extending upwardly into the hollow interior of the device. Onyshko recognizes the need to prevent the scattering of the scales as the fish is scaled, but attempts to solve the problem with a relatively small, hand held device, rather than enclosing the fish in a water filled container which is configured for ease of cleaning after the scaling operation, as is done with the present invention. The Onyshko device would prove somewhat difficult to clean, with its relatively narrow scale slot adjacent the blade.

None of the above inventions and patents, taken either singly or in combination, is seen to describe the instant invention as claimed. Thus a container for scaling fish solving the aforementioned problems is desired.

### SUMMARY OF THE INVENTION

The present container for scaling fish essentially comprises a relatively large, open top device having liquid impervious walls and a sloping floor. A drain is provided at the low point of the floor or at a low point in one of the walls, with the drain including a guard, screen, or strainer therein to preclude passage of fish scales or similarly sized material therethrough. The device may be formed of any suitable material, e.g., transparent, translucent, or opaque plastic, sheet metal, etc., as desired.

The present container is used by closing the drain, filling the container with water, placing a fish to be scaled within the water filled container, and scaling the fish within the container. Alternatively, the drain may be left open and the container placed in a sink or other container of water, if so desired. The density and viscosity of the water within the container preclude the scattering of the scales during the scaling operation, and retains the scales within the container. When the scaling operation has been completed on one or more fish, the water is drained from the container or sink in which the container was placed. The sloped floor causes the water to run toward the drain, thereby carrying the loose fish scales with the water flow. The scales collect at the drain guard or screen, where they are easily removed from the container once the water has been completely drained therefrom.

Accordingly, it is a principal object of the invention to provide an open top container with liquid impervious walls and floor, for scaling fish.

It is another object of the invention to provide such a container configured for filling with water, in order to contain scales removed from a fish during scaling operations and to prevent those scales from scattering during the scaling operation.

It is a further object of the invention to provide such a container providing for ease of cleanup after scaling operations, by means of a sloping floor and a drain placed at the low point of the floor or along the lower edge of one of the walls of the container.

Still another object of the invention is to provide a screen or guard at the drain, such that the water flow to the drain washes the loosened scales to the drain to collect at the single drain point, for ease of removal of the scales from the container after the water has been drained therefrom.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a container for scaling fish according to the present invention, showing its use and operation.

FIG. 2 is a broken away front elevation view of the lowest portion of the floor of the container of FIG. 1, showing details of the drain and cap structure thereof.

FIG. 3 is a perspective view of an alternate embodiment of the present container for scaling fish, having a raised floor with a drain depending from the floor.

FIG. 4 is a broken away front elevation view of the lowest portion of the floor of the container of FIG. 3, showing details of the drain and cap structure thereof.

FIG. 5 is an environmental perspective view of another alternate embodiment of the present container for scaling fish, showing the container placed within a water filled basin.

Similar reference characters denote corresponding features consistently throughout the attached drawings.

### DETAILED DESCRIPTION OF THE PREFERRED EMBODIMENTS

The present invention comprises a few different embodiments of a container for holding the scales removed while scaling a fish, and for facilitating disposal of the loosened scales for ease of cleanup. The present invention may be constructed in any practicable size, for sport or commercial anglers as desired.

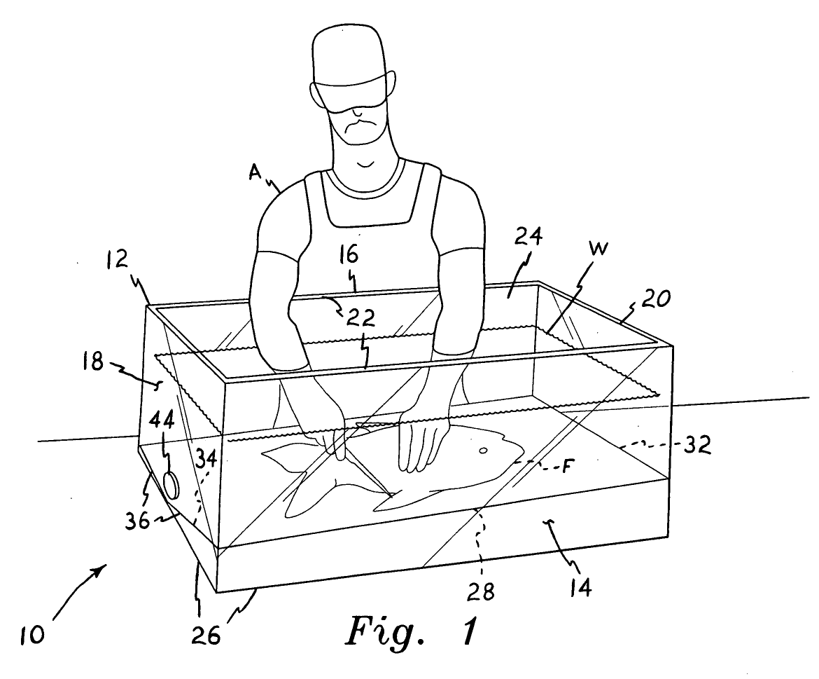

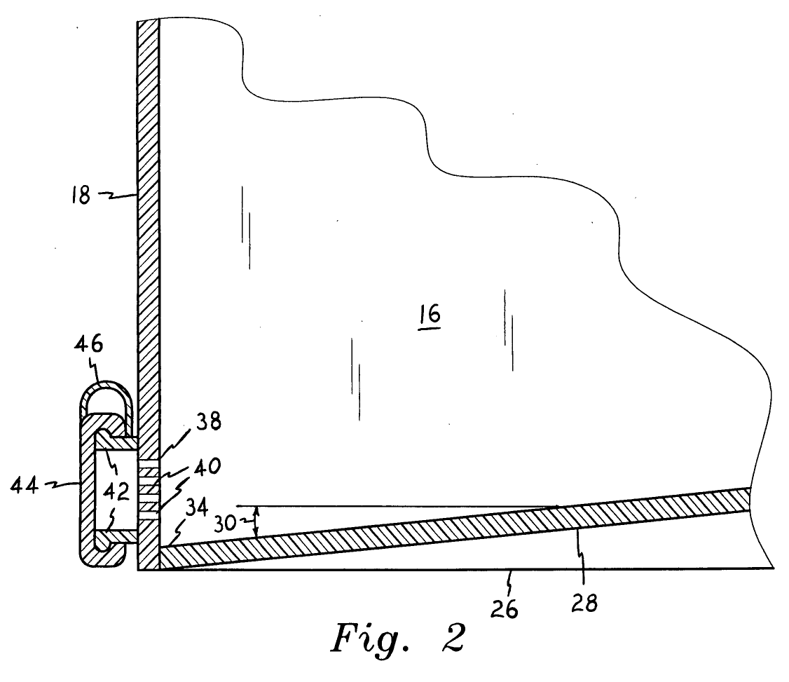

FIGS. 1 and 2 illustrate a first embodiment of the present invention, designated as container 10. The container 10 comprises an open enclosure 12 defined by at least one surrounding, liquid impervious wall. In the exemplary container 10 of FIG. 1, a series of four walls 14, 16, 18, and 20 define a rectangular enclosure 12, but it will be seen that a single wall of circular, oval, or other non-angular configuration may be provided as desired. The wall or walls, as well as the floor, may be formed of any practicable sheet material, so long as the material is impervious to the passage of liquids. Transparent plastic (e.g., acrylic, etc.) may be used, as illustrated, or alternatively a translucent or opaque plastic, or sheet metal (aluminum, stainless steel, etc.) may be used as desired to form the present container 10.

The upper edge(s) 22 of the wall or walls 14 through 20 is/are open, thereby defining an open top 24 for the container 10. The opposite lower edge(s) 26 of the wall or walls 14 through 20 form a support base for the container 10. A liquid impervious floor 28 extends across the lower portion of the enclosure, generally just above the lower edge(s) of the wall or walls 14 through 20. The floor 28 has a shallow slope 30, more readily seen in the detail view of FIG. 2. This slope 30 extends from a higher first end 32 slightly above the lower edge 26 of the fourth wall 20, to a lower second end 34 adjacent the lower edge 26 of the opposite third wall 18. The floor 28 may have a shallow V-shaped lateral cross section 36, as shown at the lower second end 34 of the floor in FIG. 1, to promote drainage flow.

The third wall 18 includes a drain 38 installed therethrough, immediately adjacent the lower edge 26 of the wall panel 18 and the lowest point in the floor 28, as shown in detail in FIG. 2. The drain 38 comprises a series of relatively small (i.e., a diameter of one sixteenth of an inch or so) passages or holes through the lower portion of the wall 18, with the passages forming a drain guard 40 to capture and prevent the passage of loose fish scales and/or other small articles therethrough. The drain 38 preferably includes a relatively short outlet lip 42 extending outwardly therefrom, with a drain cap 44 fitting tightly over the end of the outlet 42 to preclude liquid flow therefrom when the cap 44 is installed. The cap 44 may be formed of a resilient plastic material to snap in place by distending over the outlet lip 42, with a flexible connector strap 46 formed integrally with the cap 44 and outlet 42 to prevent loss of the cap 44. Alternative cap configurations may be used, e.g., threaded, etc., if so desired.

The present fish scaling container 10 is used by first capping the drain 38 and filling the enclosure 12 with water W to a level somewhat below the top 22 thereof. A fish F is then placed in the enclosure 12 and held in place by an angler A while the fish F is scaled. The loose scales cannot scatter about, as the density and viscosity of the water W prevents the relatively small and light scales from flying about when scraped from the fish F, as they do conventionally when a fish is scaled in the ambient air. Rather, the loose scales settle through the water W to the bottom of the enclosure 12, where they come to rest.

When the scaling operation has been completed, the fish F is removed from the container 10, the container 10 is moved to a convenient drainage location (if it was not placed at such a location prior to the scaling operation), and the drain cap 44 is opened to allow the water W to flow from the container 10 through the drain 38. The slope 30 and V-shaped cross section 36 of the floor 28, ensures that all water W within the container 10 will flow to the drain 38 without leaving any puddles or pockets of water behind. The flow of the water toward and through the drain 38 entrains the small and lightweight scales removed from the fish F, and carries them toward the drain 38. However, the drain guard 40 captures any and all such fine particles (fish scales, etc.) before they can pass through the drain 38, thus assuring that the water passing from the drain 38 is relatively clean and that it will not clog any drain passages due to contaminants washed from the container 10. The fish scales and/or any other small particles collect at the drain guard 40, where they are easily removed as a collected mass once the water W has completely drained from the container 10.

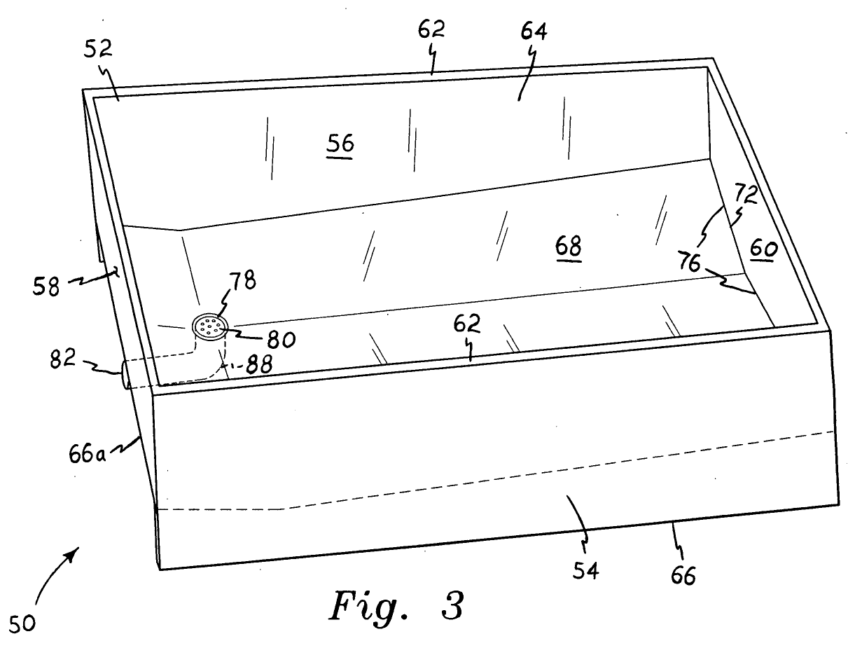

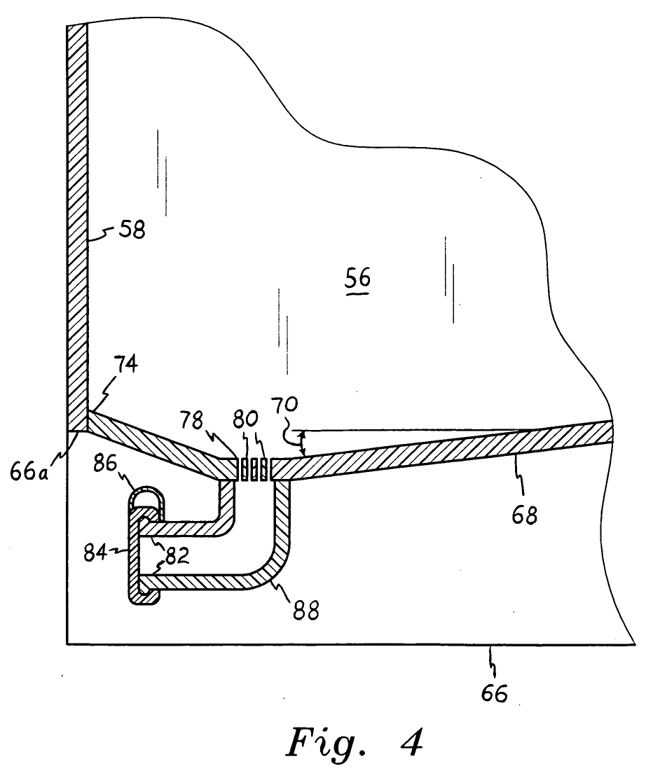

FIG. 3 of the drawings illustrates an alternative embodiment of the container 10 of FIGS. 1 and 2, designated as container 50. The fish scaling container 50 of FIGS. 3 and 4 is quite similar to the container 10 of FIGS. 1 and 2, with the only difference being the floor configuration and drain location, which passes through the floor of the container 50 rather than through the lower portion of one of the walls, as in the container 10 of FIGS. 1 and 2.

The container 50 includes an enclosure 52 defined by first through fourth walls, respectively 54 through 60. As in the case of the container 10 of FIG. 1, the enclosure 52 of the container 50 may be defined by one or more circular or non-circular walls having a non-polygonal shape, if so desired. The upper edge 62 of the container 50 defines an open top 64, with the opposite lower edge 66 providing a support base for the container 50. A floor 68 extends across the lower portion of the enclosure 12, between the walls 54 through 60. The floor 68 is positioned somewhat above the lower edge 66 of the walls 54 through 60 in order to provide clearance therebelow, for reasons explained further below. The floor 68 has a shallow slope 70, more readily seen in the detail view of FIG. 4. This slope 70 extends from a higher first end 72 somewhat above the lower edge 66 of the fourth wall 60, to the floor mounted drain. The opposite second end 74 of the floor 68 also slopes downwardly from the third wall 58 to the drain, as shown in FIG. 4. The floor 68 preferably includes a shallow V-shaped lateral cross section 76, as shown at the higher first end 72 of the floor in FIG. 3, to promote drainage flow.

The fish scaling container 50 of FIG. 3 differs from the container of FIG. 1 in that the drain 78 of the container 50 passes through the floor 68, coincident with a low point defined by the slope 70 and other slopes formed by the V-shaped configuration of the floor 68. Preferably, the drain 78 is positioned adjacent the second end 74 of the floor 68, in order to provide a relatively short run to the edge of the container.

As in the case of the container 10 of FIGS. 1 and 2, the drain 78 of the container 50 includes a drain guard 80, formed by the structure incorporating a series of relatively small passages or holes through the drain area 78 to capture and prevent the passage of loose fish scales and/or other small articles therethrough. The drain outlet end 82 includes a drain cap 84 and cap connector or attachment strap 86, as shown in FIG. 4, similar to the configuration described further above for the drain outlet 42, cap 44, and connector strap 46 for the container 10 of FIGS. 1 and 2. However, the floor drain 78 of the fish scaling container 50 of FIGS. 3 and 4, includes an elbow 88 between the drain 78 proper and the outlet end 82. This positions the cap 84 adjacent the second end 74 of the floor 68, generally beneath the lower edge 66a of the third wall 58 (which is raised somewhat to provide for access to the drain cap 84).

The fish scaling container 50 of FIGS. 3 and 4 is used in much the same manner as the container 10 of FIGS. 1 and 2, i.e. capping the drain 78, filling the enclosure 52 with water, placing a fish in the enclosure 52, and holding the fish in place while the fish is scaled. When the scaling operation has been completed, the fish is removed from the container 50, and the drain cap 84 is opened to allow the water to flow from the container 50 through the drain 78. The water flow toward and through the drain 78 entrains the scales removed from the fish and carries them toward the drain 78, with the drain guard 89 capturing the loose scales for collection once the water has drained from the container 50.

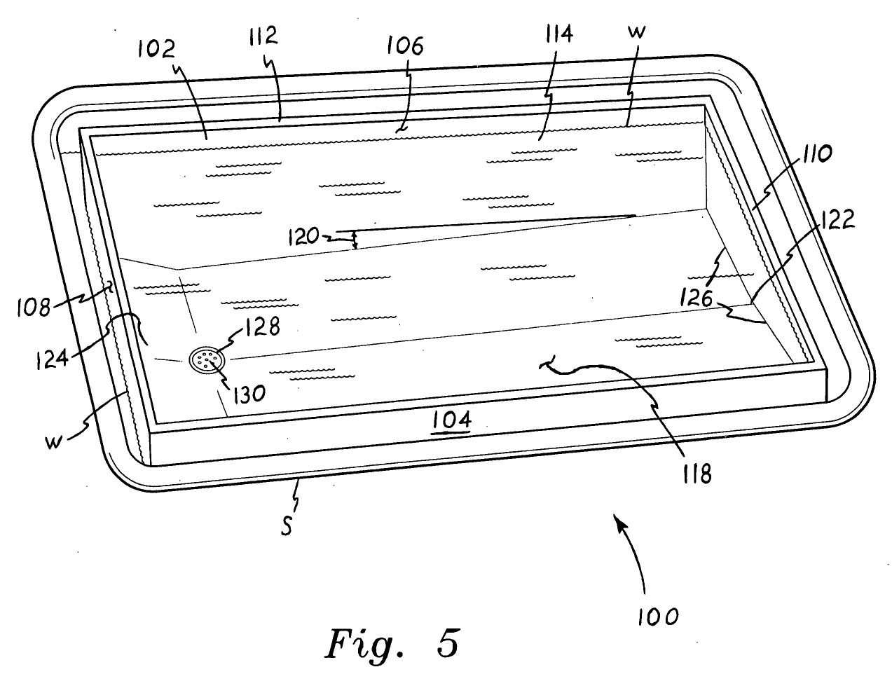

FIG. 5 illustrates an additional embodiment of the present fish scaling container, designated as container 100. The container 100 is similar to the container 50 of FIGS. 3 and 4, having an enclosure 102 defined by first through fourth walls, respectively 104 through 110, or alternatively one or more non-polygonal walls, as noted for other embodiments. The upper edge 112 of the container 100 defines an open top 114, with the opposite lower edge (not shown in FIG. 5, but similar to the embodiment of FIG. 1) providing a support base for the container 100. A floor 118 extends across the lower portion of the enclosure 112, between the walls 104 through 110. The floor 118 is preferably positioned somewhat above the lower edge of the walls 104 through 110 to provide a stable base for the container 100. The floor 118 has a shallow slope 120 extending from a higher first end 122 somewhat above the lower edge of the fourth wall 110, to the floor mounted drain. The opposite second end 124 of the floor 118 also slopes downwardly from the third wall 108 to the drain. The floor 118 preferably includes a shallow V-shaped lateral cross section 126, as shown at the higher first end 122 of the floor in FIG. 5, to promote drainage flow.

The fish scaling container 100 of FIG. 5 is similar to the container 50 of FIGS. 3 and 4, with the drain 128 of the container 100 passing through the floor 118, coincident with a low point defined by the slope 120 and other slopes formed by the V-shaped configuration of the floor 118. The specific location of the drain 128 through the floor 118 is not critical for the container 100 of FIG. 5.

As in the case of the other containers 10 and 50 of the present invention, the drain 128 of the container 100 includes a drain guard 130, formed by the structure incorporating a series of relatively small passages or holes through the drain area 128 to capture and prevent the passage of loose fish scales and/or other small articles therethrough. However, the container 100 of FIG. 5 does not include any form of drain outlet or cap assembly, as provided in the other embodiments. The reason for this is that the container 100 is intended for placement within another container or enclosure which may be filled with water, e.g. a kitchen sink S, basin, etc. As such, the container 100 is preferably formed to have a relatively small size, e.g., on the order of a foot to eighteen inches in length and somewhat narrower, in order to fit conveniently within a conventional kitchen sink S, basin, or the like.

As such sinks and basins conventionally include stoppers or plugs to prevent water from draining therefrom when filled, the conventional sink stopper or plug may be used to close the sink drain. The sink S is then filled with water W and the container 100 placed therein (or the container 100 may be placed within the sink S before filling the sink), with the water level equalizing within and outside of the container enclosure 112 due to the lack of restriction at the drain 128. A fish may then be placed within the container 100, and the container 100 used as described further above for the containers 10 and 50 for containing the loosened and removed scales of a fish during the scaling process.

When scaling has been completed and the fish removed from the container 100, the container may be lifted slightly to open the drain stopper or plug therebeneath, to allow the water W to drain from the sink S. The relatively small container 100 is easily lifted at this point, as the water therein flows through the container drain 128 to equalize the water level and provide neutral buoyancy. A remotely actuated drain stopper further facilitates the drainage operation. As the water W drains from the container 100, it carries the removed scales to the container drain 128, with the slope of the floor 118 ensuring that all water, and scales carried therewith, passes to the drain 128. The drain guard 130 captures the scales and prevents them from passing through the drain 128, with all scales being gathered in a single location at the drain 128 for ease of removal and disposal once the water has drained from the container 100.

In conclusion, the present container for scaling fish in any of its embodiments, serves to greatly facilitate the scaling of fish and the subsequent cleanup of the removed scales. The drainage of water from the present containers after scaling, washes and carries substantially all of the loosened and removed scales to the drain of the container, where they are captured by the drain guard. The accumulation of scales at the drain guard enables them to be easily removed from the container in a very simple and quick operation. The capturing of the scales in the container assures that the scales cannot flow into a conventional drain where they may clog the drain, as has occurred occasionally with conventional fish scaling methods.

The present container for scaling fish in its various embodiments is easily and economically manufactured, as the materials from which it may be manufactured (various plastics or sheet metal) are relatively inexpensive. It will be seen that the present fish scaling container may be manufactured to any practicable size as desired, from several feet long to smaller household units configured for placement in a conventional kitchen sink, basin, or other household facility. Also, while embodiments having drain caps or plugs have been disclosed herein for use away from a sink or basin, it should be noted that such embodiments having drain caps may also be used in a conventional sink or the like, if so desired. Accordingly, the present container for scaling fish in its various embodiments will greatly facilitate the scaling of fish by an angler, saving the angler considerable time and aggravation in the cleanup operation after scaling. Anglers everywhere and at every level from commercial fishing to sport fishing, will appreciate the benefits of the present invention.

It is to be understood that the present invention is not limited to the embodiments described above, but encompasses any and all embodiments within the scope of the following claims.

1. A container for scaling fish, comprising:
an open enclosure, including:
at least one closed, liquid impervious wall, having:
an upper edge defining an open top;
a lower edge opposite said upper edge;
a drain disposed through said wall, immediately adjacent said lower edge thereof;
a liquid impervious floor extending across said wall, having: a first end;
a second end opposite said first end and adjacent said drain;
said first and second ends defining a surface therebetween having a slope extending downwardly from said first end to said second end;
wherein said enclosure is adapted to be filled with water and said surface of said floor is adapted to receive a fish for scaling thereon; the fish is scaled within said enclosure, scales from the fish are precluded from scattering by viscosity and density of the surrounding water, the scales being carried by the water through the drain.

2. The container for scaling fish according to claim 1, further including a scale capturing drain guard disposed at said drain.

3. The container for scaling fish according to claim 1, further including a drain cap removably disposed at said drain.

4. The container for scaling fish according to claim 1, wherein the slope of said floor comprises a shallow V-shaped cross section toward the second end thereof.

5. The container for scaling fish according to claim 1, wherein said at least one wall and said floor are formed of a material selected from the group consisting of transparent plastic, translucent plastic, opaque plastic, and sheet metal.

6. The container for scaling fish according to claim 1, wherein said enclosure has a generally rectangular configuration.

7. (Canceled)

8. A container for scaling fish, comprising:
an open enclosure, including:
at least one closed, liquid impervious wall, having:
an upper edge defining an open top;
a lower edge opposite said upper edge;
a liquid impervious floor extending across said wall and above said lower edge thereof, having a first end;
a second end opposite said first end;
a slope extending downwardly from said second end to said first end;
a drain disposed through said floor, adjacent said second end thereof;
whereby when said enclosure is filled with water and a fish is scaled within said enclosure, scales from the fish are precluded from scattering by viscosity and density of the surrounding water, the scales being carried through said drain for ease of disposal.

9. The container for scaling fish according to claim 8, further including a scale capturing drain guard disposed at said drain.

10. The container for scaling fish according to claim 8, further including a drain cap removably disposed at said drain.

11. The container for scaling fish according to claim 8, wherein the slope of said floor comprises a shallow V-shaped cross section toward said drain.

12. The container for scaling fish according to claim 8, wherein said at least one wall and said floor are formed of a material selected from the group consisting of transparent plastic, translucent plastic, opaque plastic, and sheet metal.

13. The container for scaling fish according to claim 8, wherein said enclosure has a generally rectangular configuration.

14-20. (Canceled).

21. A container for scaling fish, comprising:
an open enclosure, including at least one closed, liquid impervious wall, and a liquid impervious floor;
said wall including an upper edge defining an open top, a lower edge opposite said upper edge said liquid impervious floor extending across said wall, having a first end, a second end opposite said first end, said first and second end defining a slope extending downwardly from said first end to said second end; and
a drain disposed adjacent to said second end, said drain including a drain guard for capturing fish scales and debris;
wherein said enclosure is adapted to be filled with water and said surface of said floor is adapted to receive a fish for scaling thereon; the fish is scaled within said enclosure, scales from the fish are precluded from scattering by viscosity and density of the surrounding water, the scales being carried by the water to and captured by the drain guard.

22. The container for scaling fish according to claim 21, wherein said drain is disposed through said wall adjacent said second end.

23. The container for scaling fish according to claim 21, wherein said drain is disposed through said floor adjacent said second end.

24. The container for scaling fish according to claim 21, further including a drain cap removably disposed at said drain.

25. The container for scaling fish according to claim 21, wherein the slope of said floor comprises a shallow V-shaped cross section toward the first end thereof.
